(19) United States
(12) Patent Application Publication
(10) Pub. No.: US 2009/0071788 A1
(43) Pub. Date: Mar. 19, 2009

(54) ONE-WAY CLUTCH

(75) Inventor: Norihiro Yamamoto, Fukuroi-shi (JP)

Correspondence Address: SUGHRUE-265550, 2100 PENNSYLVANIA AVE. NW, WASHINGTON, DC, 20037-3213, US

(73) Assignee: NSK-WARNER KABUSHIKI KAISHA, Tokyo (JP)

(21) Appl. No.: 12/204,524

(22) Filed: Sep. 4, 2008

(30) Foreign Application Priority Data
Sep. 4, 2007 (JP) 2007-228473

(51) Int. Cl. F16D 41/061; F16D 41/067

(52) U.S. Cl. 192/45

(57) ABSTRACT

A one-way clutch 10 has rollers 24, block bearings 30 and a cage 40 between outer and inner rings 21, 23. A cam surface 27 formed by a valley portion 25 and an inclined surface 26 is formed on an inner circumferential surface of the outer ring 21 so as to correspond to the rollers 24. A spring 33 is interposed between a recessed portion 31 of an inner circumferential surface of the outer ring 21 and a recessed portion of the block bearing 30 and biases the roller 24 against the cam surface 27 via the cage 40. The one-way clutch 10 engages when the inner ring 23 rotates along arrow F and idles when the inner ring 23 rotates along arrow R. Because the springs 3 are not necessarily provided for each of the rollers 24, the number of components is reduced and ideal torque capacity is obtained.

### BACKGROUND OF THE INVENTION

1. Field of the Invention

The present invention relates to a one-way clutch incorporated to a vehicular automatic transmission.

2. Description of Related Art

FIG. 5 is a front view showing a configuration of a conventional one-way clutch. In the one-way clutch, a torque transmitting roller 24, block bearing 30 and a cage 40 which are made of synthetic resin and have side flanges connected each other via columns 51 are interposed between an outer ring 21 and an inner ring 23. The roller 24 is biased by an accordion spring 50 interposed between the roller 24 and the column 51. Valley portions 25 and cam surfaces 27 formed by inclined surfaces 26 are formed on an inner circumferential surface of the outer ring so as to correspond to respective rollers 24.

A projecting portion 54 of the block bearing 30 fits into a recessed groove 55 on an inner circumferential surface of the outer ring 21. The outer ring 21 and the block bearing 30 are locked each other via a protrusion 52 and a lip of the column 51. A reference number 22 denotes a spline tooth which engages with another member.

When the inner ring 23 rotates along arrow “R”, the roller 24, which is biased by the accordion spring 50 interposed between the column 51 and the roller 24, moves toward the inclined surface 26 of the cam surface 27. Thus, the one-way clutch is engaged. As for the conventional one-way clutch, for example, Japanese Unexamined Patent Publications Nos. JP-A-2003-083365 and JP-A-308719 are exemplified.

In the conventional one-way clutch, as described above, a number of components is large, such as respective springs being required for respective rollers. Further, because the respective springs is required for the respective rollers and their properties fluctuate in each spring, when engaging the clutch, it is difficult to engage respective engagements (movement of the roller) in a synchronized manner. Thus, ideal torque capacity cannot be obtained.

### SUMMARY OF THE INVENTION

According to an aspect of the invention, there is provided a one-way clutch including:

an inner ring and an outer ring and

torque transmitting rollers, a cage and block bearings interposed between the inner and outer rings, wherein

a cam surface formed by a valley portion and an inclined surface is formed on an inner circumferential surface of the outer ring and

the block bearing has an elastic body which biases the torque transmitting roller against the cam surface via the cage.

According to another aspect of the invention, it is advantageous that the elastic body of the block bearing is interposed in a space defined between the block bearing and the outer ring.

According to another aspect of the invention, it is advantageous that the cage has curved surfaces formed on surfaces which receive pressure from the roller when the one-way clutch is engaged and a curvature of the curved surface corresponds to a shape of the roller.

According to the invention, because a spring between the rollers and a side plate can be omitted, the number of components can be reduced and the engagement of the one-way clutch can be performed in a synchronized manner to realize ideal torque capacity. In addition, the roller is held by the cage, falling off of the roller from the assembly at the time of transporting or assembling the assembly can be prevented.

### BRIEF DESCRIPTION OF THE DRAWINGS

FIG. 1 is a front view of a one-way clutch of the present invention;

FIG. 2 is a sectional view of line II-II of FIG. 1;

FIG. 3 is an enlarged view of a main part of FIG. 2;

FIG. 4 is an enlarged view of a main part of FIG. 1 and

FIG. 5 is a view showing a conventional one-way clutch.

### DETAILED DESCRIPTION OF THE PREFERRED EMBODIMENTS

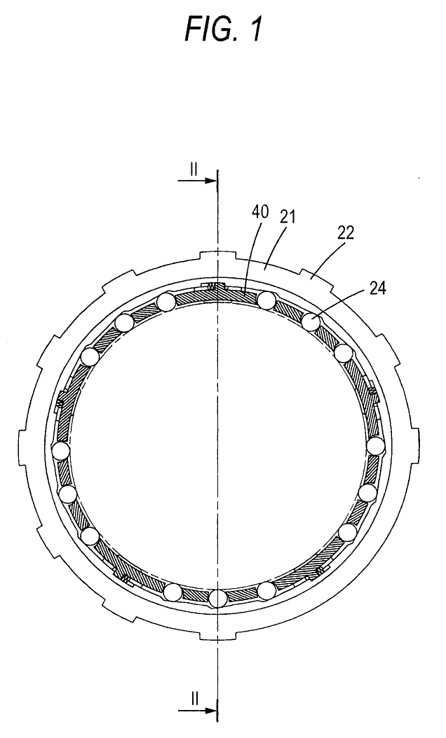

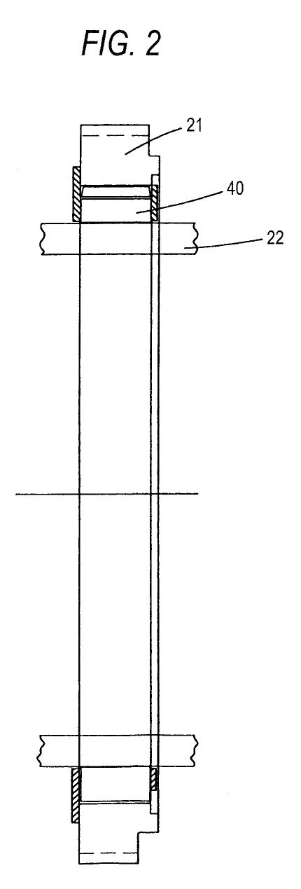

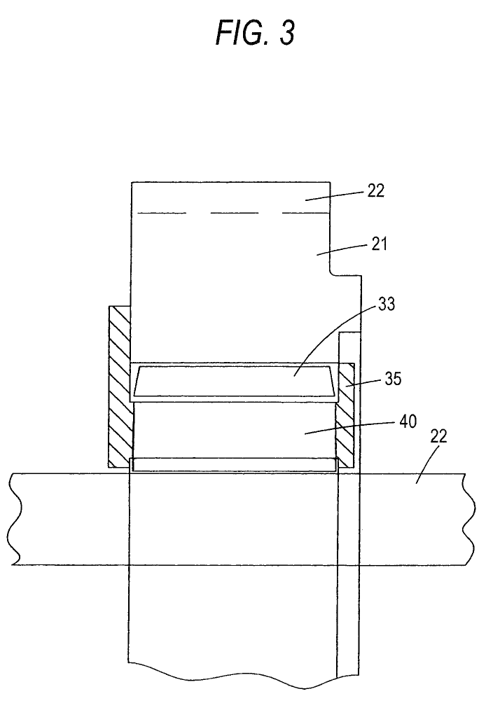

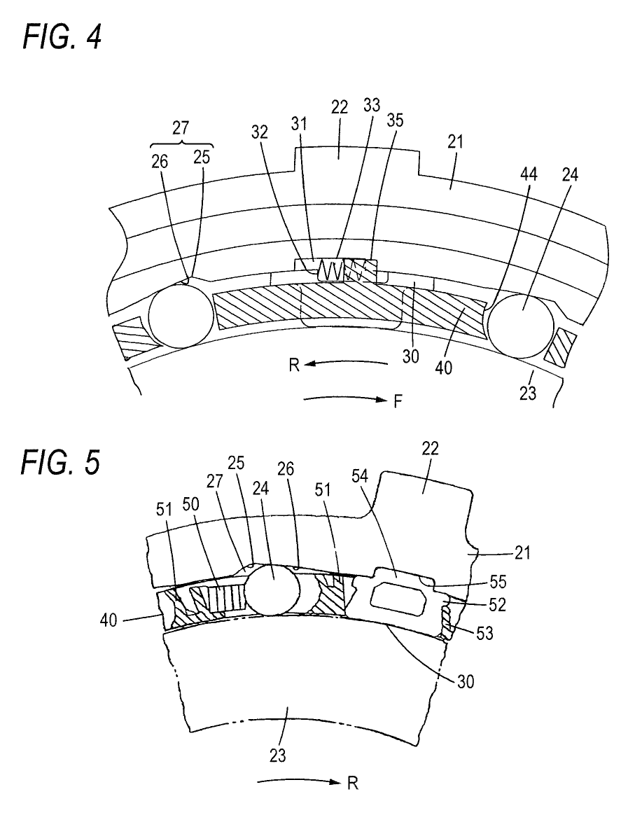

FIG. 1 is a front view of a one-way clutch of the present invention, FIG. 2 is a sectional view of line II-II of FIG. 1, FIG. 3 is an enlarged view of a main part of FIG. 2, FIG. 4 is an enlarged view of a main part of FIG. 1 and FIG. 5 is a view showing a conventional one-way clutch.

A one-way clutch 10 includes an outer ring 21, inner ring 23, power transmitting rollers 24 interposed between the outer ring 21 and the inner ring 23, block bearings 30, a cage 40. The block bearing 30 is made of oil-impregnated sintered alloy. This block bearing 30 is disposed between the outer and inner rings 21, 23 and slidingly contacts with the outer and inner rings 21, 23 while maintaining a clearance between the outer and inner rings 21, 23, as shown in FIG. 4.

The cage 40 is made of synthetic resin. This cage 40 is a circular integrated cage and holds the rollers 24 in respective roller accommodating spaces, as shown in FIGS. 1 and 4. The block bearing 30 can move integrally with the cage 40 in a circumferential direction.

As shown in FIGS. 2 and 4, a cam surface 27 formed on an inner circumferential surface of the outer ring 21 is formed by a valley portion which is recessed towards radially outwardly and an inclined surface 26 which extends from the valley portion 25 in radially inwardly. The inclined surface 26 is configured such that the distance between the inclined surface 26 and the inner ring 23 is shorter than the diameter of the roller 24 at a position where is apart from the valley portion.

When the inner ring 23 rotates along the arrow “F” indicated in FIG. 4, the roller 24 moves along arrow “F”, too. That is, the roller 24 moves from the inclined surface 26 side to the valley portion 25 side. Because, in the vicinity of the valley portion 25, a large space which is larger than the diameter of the roller 24 is formed, the roller 24 freely rotates (idles) in the vicinity of the valley portion 25. Thus, the inner ring 23 can continuously rotate and the one-way clutch 10 is disengaged.

On the other hand, when the inner ring 23 rotates along with the arrow “R” indicated in FIG. 4, the roller 24 moves along the arrow “R”, too. That is, the roller 24 moves from the valley portion 25 side to the inclined surface 26 side. At this time, since the spring 33 biases the roller 24 to the inclined surface 26 side via the cage 40, the roller 24 moves to the inclined surface 26 side instantly when the inner ring 23 rotates along arrow R. When the roller 24 moves to the inclined surface 26 side and held between the inclined surface 26 and the inner ring 23, the roller 24 cannot rotate and the inner ring 23 cannot rotate, either. Thus, the one-way clutch 10 is engaged.

As shown in FIG. 4, at predetermined area of the cage 40, springs 33 are interposed between a recessed portion 31 of an inner circumferential surface of the outer ring 31 and a recessed portion 32 formed on the block bearing 30, respectively. That is, according to the present invention, the block bearings 30 and the springs 33 are provided at only the predetermined area of the cage 40, the block bearings 30 and the springs 33 are not disposed between each rollers 24. Therefore, although the number of the block bearings 30 and the springs 33 should be the same of the number of the rollers 40 in the conventional configuration, according to the present invention, the number of the block bearings 30 and the springs 33 is lower than the number of the rollers 24. For an example, with respect to fifteen rollers, only five or six block bearings and springs are required.

The spring 33 biases a side surface which forms part of the recessed portion 32 of the block bearing 30 and biases the block bearing 30. Since the block bearing 30 moves integrally with the cage 40 in the circumferential direction, the biasing force transmitted to the block bearing 30 is transmitted to the cage 40. Thus the biasing force transmitted to the cage 40 also biases the roller 24 via the cage 40.

As shown in FIG. 4, the cage 40 has projecting portions 35 which is provided on a side surface of the cage 40 and projects toward the outer ring 21 side (that is, radially outer direction).

A projecting length of the projection portion 35 in the radially outer direction is equal to or less than a depth of the recessed portion 31 of the outer ring 21. Thus, after inserting the cage 40 into the outer ring 21 from axial direction by passing the cage 40 at the recessed portion 31 of the outer ring 21, by shifting the cage 40 in circumferential direction, the cage 40 is prevented from falling off from the outer ring 21 in axial direction.

Further, a process in which the spring 33 is attached to a space between the recessed portion 31 of the outer ring 21 and the recessed portion 32 of the block bearing 40 is after a process of attaching the inner ring 23 to the outer ring 21. Thus, the roller 24 does not continuously abut with the cam surface 27 and the inner ring 23 and the movement and rotation of the roller 24 is not prevented. Accordingly, the roller 24 can move in the circumferential direction, the block bearing 30 is also movable along the circumferential direction. Therefore, the positions of the recessed portion 31 of the outer ring 21 and the recessed portion 31 of the block bearing can be easily matched and the spring 33 can be interposed therebetween easily.

According to the present invention, because the spring is not interposed in all of the spaces between the rollers, the number of the components can be reduced. Further, the engagement of the clutch can be performed in a synchronized manner and ideal torque capacity can be achieved.

Further, a curved surface 44 is formed on surfaces of the cage 40, which receive pressure from the roller 24 at the time of engagement of the one-way clutch 10, so that a curvature of the curved surface corresponds to a shape of the roller 24. In other words, the curved surfaces 44 are formed on respective surfaces which form the roller accommodating spaces. Due to this configuration, the falling off of the roller from the one-way clutch 10 at the time of transporting or assembling of the one-way clutch 10 can be prevented.

As described above, according to the present invention, disposing the spring on the every space between the rollers is omitted, the number of the components is reduced and the engagement of the clutch can be performed in a synchronized manner, ideal torque capacity can be obtained. Of course, as the spring 33 biasing the block bearing 30, an accordion spring, a coil spring, rubber or silicone rubber which realize the present invention can be employed.

While the invention has been described in connection with the exemplary embodiments, it will be obvious to those skilled in the art that various changes and modifications may be made therein without departing from the present invention, and it is aimed, therefore, to cover in the appended claim all such changes and modifications as fall within the true spirit and scope of the present invention.

What is claimed is:

1. A one-way clutch comprising:
an inner ring and an outer ring and
torque transmitting rollers, a cage and block bearings interposed between the inner and outer rings, wherein
a cam surface formed by a valley portion and an inclined surface is formed on an inner circumferential surface of the outer ring and
the block bearing has an elastic body which biases the torque transmitting roller against the cam surface via the cage.

2. The one-way clutch as set forth in claim 1, wherein
the elastic body of the block bearing is interposed in a space defined between the block bearing and the outer ring.

3. The one-way clutch as set forth in claim 1, wherein
the cage has curved surfaces formed on surfaces which receive pressure from the roller when the one-way clutch is engaged and
a curvature of the curved surface corresponds to a shape of the roller.

4. The one-way clutch as set forth in claim 1, wherein
the number of the block bearings is lower than the number of the rollers.

5. The one-way clutch as set forth in claim 1, wherein
the number of the springs is lower than the number of the rollers.
